(19) United States
(12) Patent Application Publication
(10) Pub. No.: US 2016/0144433 A1
(43) Pub. Date: May 26, 2016

(54) METHOD AND DEVICE FOR PRODUCING A THREE-DIMENSIONAL SURFACE STRUCTURE OF A PRESSING TOOL

(71) Applicant: HUECK RHEINISCHE GMBH, Viersen (DE)

(72) Inventor: Wolfgang STOFFEL, Kempen (DE)

(73) Assignee: HUECK Rheinische GmbH, Viersen (DE)

(21) Appl. No.: 14/899,615

(22) PCT Filed: Jun. 16, 2014
(86) PCT No.: PCT/DE2014/000304

§ 371 Date: Dec. 21, 2015

(30) Foreign Application Priority Data
Jun. 19, 2013 (DE) 10 2013 010 160.3

(51) Int. Cl. B22F 7/04; B29C 67/00; B29C 59/04; B22F 3/105; B29C 59/02

(52) U.S. Cl. CPC B22F 7/04; B22F 3/1055; B29C 59/026; B29C 59/046; B29C 67/0051; B33Y 10/00

(57) ABSTRACT

The invention relates to a method for producing a surface structure of a pressing tool, in particular a pressing plate or endless belt, for pressing material plates, plastic films, separating films, PVC surfaces and LVT (luxury vinyl tiles), check cards, passports, credit cards or plastic cards, comprising the following steps:
providing and using digitized data of a 3-D topography of a surface structure,
creating digitized data of individual 2-D layers of the 3-D topography,
using the digitized data of the 2-D layers to guide a processing head and/or to position it in an x-y plane, or to move a work table in the plane spanned by an x-y coordinate system in relation to a stationary processing head, in order to connect a layer material to an existing carrier material or an already completed layer on the basis of the digitized data of the 2-D layers.

The invention relates to a method for producing a surface structure of a pressing tool, in particular a pressing plate or endless belt, for pressing material plates, plastic films, separating films, PVC surfaces, LVT (luxury vinyl tiles), check cards, passports, credit cards or plastic cards.

Material plates, for example wooden boards, are needed for the furniture industry and for interior construction, for example for laminate flooring. The material plates have a core made from MDF or HDF, and different layers of material are applied to at least one side, for example a decorative layer and a protective layer (overlay layer). To prevent warping of the finished material plates, an identical number of material layers is usually used on both sides of the material plate, and the material plate is pressed in a press using pressing plates or endless belts whilst at the same time applying surface embossing. It is standard practice to use hot presses in order to bond the different material layers of thermosetting resins, for example melamine resin, due to the effect of heat by fusing the plastic materials onto the surface of the core.

The decorative layers enable different patterns and color schemes to be obtained and the pressing plates or endless belts enable surface structuring to be applied. For example, a wood or felt decoration can be printed on decor paper or structures stylistically designed to suit the corresponding application may be used. In this context, the decor papers may also have an overlay layer with print on the top or reverse face.

To make the simulated design realistic, especially in the case of wood patterns, felt patterns or natural stone surfaces, the pressing plates or endless belts are provided with a surface structure embossed in-register with the printed layer and have a negative imprint of the surface structure to be applied. For this reason, the pressing plates or endless belts have depth structuring, for example corresponding to the wood grain of a wood surface visible from the decorative layer. Depth structuring may also be provided in-register with decorative layers of different types. Another option is for the pressing plates or endless belts to be produced with less pronounced structuring in order to obtain greater partial surface pressing without imparting deep structures.

To make the simulated design even more realistic, especially in the case of wood patterns, felt patterns or natural stone surfaces, pressing plates or endless belts are used which also have a specific gloss level. With the aid of a digitized printing technique for the decor papers and using a digitized method of producing the pressing plate surfaces, an accurate alignment can be obtained which comes very close to a natural wood panel or similar materials due to an exact orientation. Setting a specific gloss level also offers the possibility of creating reflection or shadowing which gives an observer the impression of a natural wood surface or other similar materials.

In order to obtain in-register embossing of the material plates, the pressing plates and endless belts must be manufactured to a high quality standard which in particular results in embossing exactly aligned with the specific decorative layers. The pressing plates or endless belts in this case are used as a top and a bottom tool in short-cycle presses equipped with pressing plates or double belt presses in the case of endless belts, and embossing and heating of the overlay layers takes place simultaneously so that the thermosetting resins can be bonded to the core by melting and setting.

The digitized data of a motif template that is available is used to apply an etch resist for the structuring of the pressing plates or endless belts to be applied. For this purpose, an etch resist is applied to the pressing plates or endless belts with the aid of a digital printer for example, so that an etching process can then be implemented. Once the etch resist has been removed, further processing may than take place and in the case of particularly deep surface structuring, several etching processes are preferably carried out one after the other. To this end, an etch resist is again applied to the already etched pressing plate or endless belt and another etching process implemented until a structure of the desired depth is obtained. During the individual etching processes, coarse or fine structuring may also be obtained, depending on what type of motif is used for the decorative layers. Production by etch resist as described above is based on the latest technology, whereas screen printing processes were previously used to produce etch resists for example, prior to the etching process itself.

In the case of both the new and the older production methods, an etch resist is applied to the plates in order to simulate the raised surface structures by means of the covered regions of the etch resist, whilst the spaces in between undergo surface etching. The etched regions then form the profile valleys of the desired structure resulting in a negative shape. After each etching process, the surface is cleaned an optionally a new mask applied so that further etching processes can be implemented or so that the surface quality can be improved by another process, for example hard chromium plating, adjustment of the gloss level, etc.

The process of applying the etch resist using a screen printing method or digital printing followed by etching is relatively time-consuming, which means that the process of producing the plates incurs high costs.

If material plates have to be pressed in particular, pressing tools in the form of pressing plates or endless belts based on a large format are used which have at least one edge length of more than one meter.

The pressing tools may also be used for pressing plastic films, separating films, PVC surfaces, LVT, in which case the size of the pressing tools is adapted to the end products. Another option is to press check cards, passports, credit cards or plastic cards with the pressing tools and in this case it is features relevant to security that are important. If the security-relevant features are applied to the decorative layers, pressing is usually implemented with a smooth or lightly structured pressing tool. Alternatively, another option is to use pressing tools to emboss security-relevant features of the decorative layer into the surface as well.

The underlying objective of this invention is to propose a new type of method whereby the structured surface of the pressing tools can be produced in an environmentally friendly manner and production can be rationalized.

As proposed by the invention, this method objective is achieved by the fact that a surface structure of a pressing tool, in particular a pressing plate or endless belt, is produced with the aid of a 3-D layered structure and the method comprises the following steps:
providing and using digitized data of a 3-D topography of a surface structure,
creating digitized data of individual 2-D layers of the 3-D topography,
using the digitized data of the 2-D layers to guide a processing head and/or position it in an x-y plane, or to move a work table in a plane spanned by an x-y coordinate system relative to a stationary processing head, in order to connect a layer material to an existing carrier material or an already completed layer on the basis of the digitized data of the 2-D layers.

Other advantageous embodiments of the invention are disclosed in the dependent claims.

Based on the new method, the pressing plates or endless belts are produced using a 3-D layer structure. For this purpose, digitized data provided for a 3-D topography is used to produce digitized data of individual 2-D layers with the aid of the 3-D topography. The number of 2-D layers depends on the desired structure depth, i.e. from the highest to the lowest point of the structure to be created. As a rule, in order to produce surface structuring for pressing plates or endless belts using an etching process, a depth structuring of 80μ is obtained. In individual cases, however, this structure may extend to a depth of up to 400μ. The same applies when producing pressing plates or endless belts using a 3-D layer structure. The higher the subsequent penetration depth of the pressing tools, the greater the difference between the lowest and highest point must be, so that a plurality of individual 2-D layers must be produced in each case using a processing head.

The digitized data of the 2-D layers enables a processing head to be guided and/or positioned in an x-y plane, or enables a work table to be moved in the plane spanned by an x-y coordinate system relative to a processing head that is held stationary in order to join a layer material to an existing carrier material or to an already completed layer on the basis of the digitized data of the 2-D layers. Depending on the layer material used, the processing head enables a selected surface area to be processed in such a way that the layer material is joined to the existing base, be it a carrier material or an already completed layer. Depending on which processing head is used, it may be that a laser beam or an electron beam is guided, for example. In the case of a printing-type processing head, it can be moved above the pressing tool in an x-y plane and the work table remains stationary. Alternatively, the work table can be moved in an x-y plane in special applications where the processing head is held in a fixed position. However, this does not rule out a situation in which both the processing head and the work table are moved with a view to fast processing. In the case of a stationary work table, several independent processing heads may be used and moved, for example. It is therefore possible to control the processing head using the available digitized data of the 2-D layers and essentially follow the contours of the surface structure to be produced in order to provide a connection to the newly applied layer material.

Due to the digitized data, it is possible to control the processing head exactly so that in effect, a virtually identical reproduction of the surface structure can be made several times, or several layers can optionally be disposed one on top of the other in steps. To this end, it is merely necessary to provide digitized data of a 3-D topography which reproduces the simulated natural surface structure. The 2-D layers computed from the digitized data of the 3-D topography are then used to control the processing head in the plane spanned by an x-y coordinate system to enable a movement of the processing head into a specific position with the aid of the digitized data. This offers the possibility of applying a partial layer arrangement by means of the processing head in order to simulate the desired surface structuring.

The specific advantage of this invention resides in the fact that the layer material is solidified with a constantly high accuracy, thereby avoiding faults or undesired overlapping of the structures. The method proposed by the invention enables both coarse structuring of the surface and fine structuring of the surface to be obtained, in which case an etching process can optionally be dispensed with altogether. Another major advantage is that the digitized data enables reproducibility any number of times and does so without the need for complex control procedures, which means that monitoring by operating personnel can be kept to a minimum. Another particular advantage is that etching processes which are used in the prior art and are damaging to the environment can be largely avoided. The approach outlined above is of particular advantage when it comes to producing pressing tools such as pressing plates or endless belts based on a large format. By large format pressing tools in this context is meant a pressing tool with at least one edge length of more than one meter. Pressing plates are typically produced with a size of 3×6 meters.

For the layered structure, a layer material is used in solid, liquid, paste, gaseous or powdered form and is adhered to the existing carrier body or previously applied layers by means of the processing head. If the layer material is liquid or a paste, it is also possible to work with 3D printing.

Based on another embodiment of the method, the processing head is provided as a means of generating electromagnetic radiation, and in particular infrared radiation or laser light with one or two wavelengths is used and/or the processing head emits an electron beam. The layer material applied is cured by means of the electromagnetic radiation or an electron beam, in which case the processing head may be an infrared lamp, a UV lamp, a laser or an electron beam source.

If an electron beam is used for the processing head, it can be deflected in a manner akin to a CRT television by means of a processing head that is at least partially stationary, and the digitized data of the 2-D layers can be used for this purpose.

Depending on the type of processing head used, different layer materials may be used, for example metals such as iron, gold, copper, titanium, etc., or plastics such as ABS and resins or a powder. The layer materials may be joined to a carrier material with a high resolution up to the nanometer range by a sintering process or polymerization. The carrier material is a pressing tool, for example a pressing plate or endless belt.

The three-dimensional layered structure may be applied with solid, liquid or gaseous materials, for example, which are partially applied in layers and solidified and in the case of liquid materials, polymerization is the main method whilst in the case of gaseous materials a chemical reaction is used. In terms of solid materials, it is possible to use wires, single or multi-component powders as well as films. If using solid materials, for example a wire, the latter can be melted and solidified on the carrier body. Single or multi-component powders are solidified by means of a binding agent or used for melting followed by setting, in which case a laser is used for “selective laser sintering” (SLS). If films are used, these can be adhered to the carrier body by cutting and joining or polymerization. The remnants of film are then removed and the method is continued with at least one other film. Liquid materials are preferably polymerized, and this is done with the aid of heat, light of two wavelengths or light of one wavelength. Light of one wavelength may be applied by a lamp, laser beam or by means of holography, for example.

A known method is additive layer manufacturing, whereby powder is used as a basis for the three-dimensional layered structure, for example based on 3-D printing. Such a 3-D printer has one or more print heads which operate in a similar manner to a conventional ink jet printer. Instead of ink, however, a liquid adhesive (binding agent) may be applied to the powder layer by means of the print heads. The 2-D layers of a 3-D topography are used as a basis for this. In the case of 3-D printing with powder, the lowermost layer is provided with liquid adhesive on top of the powder layer applied by a moving print head. The 3-D printer thus prints a 2-D image of the first layer on the carrier material with the powder layer so that the individual material particles are adhered to one another on the carrier material. A new, extremely thin powder layer is then automatically applied on top of the first layer and the process repeated with the second layer. Layer after layer is applied in this manner until the desired 3-D topography has been created. The 3-D structure is therefore able to grow from the bottom upwards, the powder layer being applied to the solidified layer each time. The amount of material is calculated so that the layers become joined to another, in particular adhere. The powder and the adhesive may be different materials. For example, plastic powder or ceramic glass and other powdered materials may be processed. This approach represents the simplest option of producing a three-dimensional layered structure.

The method used to produce pressing plates or endless belts is preferably a sintering process (selective laser sintering; SLS). In this case, metal powder materials are processed but by contrast with 3-D printing, they are not joined by means of a liquid plastic but are melted with the aid of a high-power laser. In addition to plastic, this approach also enables metals, ceramics and sand to be processed.

Another sintering method (selective laser melting; SLM) may also be implemented with the aid of powdered materials and a laser whereby the powdered materials are melted, i.e. completely melted, thereby enabling a very high density of the resultant surface structure to be obtained. In the case of electron beam melting (electronic beam melting; EBM), a similar principle is used to fuse powdered metals with one another by means of a readily controllable electron beam, and the electron beam can be easily manually controlled and produces a high accuracy in terms of resolution.

Another option is 3-D printing by means of molten materials (fuse deposition modelling; FDM). This is one of the most popular methods of printing with molten materials for which plastics such as ABS or PLA are primarily used for 3-D printing in conjunction with liquid materials, and it is preferable to use liquid plastics that are sensitive to UV (photopolymers). One known process is stereolithography (STL; SALA). Based on this approach, a tank is filled with a liquid epoxy resin and this special plastic has the particular property of setting after a specific time when exposed to light. In order to produce a 3-dimensional object in this case, the individual layers of a 3-D model are projected onto the surface of the liquid material by means of a laser as soon as the first layer has set, and the carrier body is moved downwards by the height of one layer structure so that liquid resin or plastic is again able to accumulate on top of it or is applied by means of a mechanical arm. The next layer is then projected and the liquid resin, for example epoxy resin, sets. On completion of the layered structure, the still not fully set object is removed from the bath and is often then placed in a separate lighting chamber and illuminated until fully cured. Other methods are digital light processing (DLP) and multi jet modelling (MJM). Alternatively, it is also possible to use the film transfer inejing method (FTI) whereby a transport film absorbs a light-sensitive plastic which is cured by means of the processing head to obtain the desired structure.

Of the above methods, sintering is preferably the recommended method for producing pressing plates because in this case, metals which intrinsically have an adequate dimensional stability can be built up in a layered arrangement. However, plastic materials may just as easily be used, which are melted on the metal carrier body. Prior to applying the metal by electrolytic deposition, the electrically non-conductive plastic material on the carrier surface must be provided with an electrically conducting layer. This may be done by spraying on a solution containing silver or a solution containing a reducing agent. The plastic material with the precipitation of silver is then treated in a galvanic bath so that a metal layer of a non-ferrous metal is deposited on the structured carrier surface, for example copper, nickel or brass. A layer of chromium with at least a degree of gloss can then be applied.

In order to process the surface structure to be produced on the carrier material exactly, the processing head is moved at a distance of 1 cm to 20 cm from the surface. Furthermore, in this context, depending on a change in distance which might occur between the surface and processing head, for example due to slight irregularities of the carrier materials, the processing head is moved on an automatic basis. As a result, with otherwise constant control data of the processing head, the width of the surface to be processed is not changed in the event of a change in distance.

Based on another embodiment of the method, it is preferable to use digitized data of a surface structure of raw materials that have occurred naturally, such as, for example, wood surfaces or natural minerals, in particular natural stone surfaces, or synthetically produced structures, for example ceramic surfaces. Using the three-dimensional layered structure, therefore, all desired surface structures can be applied to the pressing plates or endless belts so that they can ultimately be used for pressing material plates. If the pressing tools are to be used for pressing plastic films, separating films, PVC surfaces or LVT, they may also be based on natural surface structures or synthetic surface structures. If pressing check cards, passports, credit cards or other plastic cards, features relevant to security will usually be more prevalent, applied either by external pressing on the decorative layer only or optionally also using the pressing tool to press into the outermost layer in addition. In this case, these might be emblems, company names or specific graphic symbols.

Based on another embodiment of the method, a 3-D scanner is used to record the surface structure and compute digitized data in order to set up a 3-D topography, in which case the entire surface of the templates is accurately scanned by means of a deflectable mirror, or the entire surface structure is scanned by means of a laser beam deflected by at least one mirror, thereby enabling the reflections obtained to be recorded. A 3-D microscope could also be used, additionally supplying sufficient and improved data of the depth structure. Alternatively, gray scale images of a surface structure may be used. The digitized data of the 3-D topography obtained from these are then converted into the 2-D layered structure so that the processing head can be controlled.

In order to simplify recording of the existing digitized 3-D data and in particular additional processing, another embodiment of the method is proposed whereby the digital 3-D data is converted, in particular by interpolation and data reduction, in order to determine the digitized data of the 2-D layers and control the processing head.

For the three-dimensional layered structure used to produce the surface structuring, it is preferable if, independently of a repeating pattern, the surface structure is divided into part-regions which are sequentially processed in each case or at least some of which are processed in parallel by several processing heads. In this respect, the boundaries of the part-regions are freely selectable and are preferably set up in such a way that the boundaries coincide with unprocessed regions of the surface so that any technically induced inaccuracies occurring during surface structuring are not evident. Depending on the processing head used, the set part-regions have an edge length of 10 cm to 100 cm, preferably 50 cm.

During implementation of the method, the laser beams of a laser or an electron beam of an electron beam source hit the surface at an angle relative to the vertical (z-coordinate). In this context, the laser or electron beam can be focused onto a diameter of 2 nm to 10 nm.

To enable stoppages to be made for technical reasons during surface structuring, i.e. when applying the layer material used and then carrying out other processing, another advantageous embodiment of the method is one where measurement points are provided on the surface, which enable the position of the processing head to be checked at any time so that a correction can be applied and the processing head is able to resume its work exactly in the position it was prior to the stoppage.

Once the structuring has been applied, the completed pressing plates or endless belts may be subjected to other processing methods. For example, several chromium layers with different degrees of gloss may be applied, in which case a full-surface chrome plating is applied first of all and either the raised or deeper lying regions of the surface structuring are covered with a mask so that at least a second chrome plating layer can then be applied. Alternatively, another option is to adjust the degree of gloss using gloss baths, mechanical treatment or surface etching. On completion of these other method steps, the pressing plate or endless belt is finished and can be used for the intended purpose.

Another objective of this invention is to propose a device, by means of which a three-dimensional layered structure can be applied to large-format pressing plates or endless belts by the method proposed by the invention.

As proposed by the invention, the device objective is achieved due to the fact that the device comprises at least one supporting means for the materials to be processed, at least one processing head and a guide carriage for guiding and/or moving the processing head into any position or moving a work table within a plane spanned by an x-y coordinate system, as well as independent drive elements for moving into position and a control unit provided as a means of guiding, positioning and controlling the processing head or work table. To this end, the x- and y-coordinates are set on the basis of the digitized data of individual 2-D layers of the 3-D topography and the layer material used is solidified with the aid of the at least one processing head.

The device used to implement the method firstly comprises a supporting means on which the pressing plates or endless belts can be mounted. Due to the size of the pressing plates or endless belts to be processed, having at least one edge length of more than one meter, this supporting means must be of a large-format design and provide a flat support for the pressing plates or endless belts. A guide carriage enables the processing head to be moved in a plane spanned by an x-y coordinate system, and independent drive elements are provided for moving into position. A control unit provides an input for the digitized data of the individual 2-D layers of the 3-D topography so that the processing head or, if the processing head operates in a fixed position, the work table can be guided, positioned and controlled. The purpose of the processing head used is to set the layer material used, applied in powdered form, paste, gaseous or liquid form.

Based on another embodiment of the claimed device, one or more processing heads are disposed in one coordinate direction in the plane and can be moved jointly in the direction of the other coordinate. The processing heads may be disposed at a distance of 1 cm to 20 cm from the surface and an area with an edge length of 10 cm to 100 cm, preferably 50 cm, can be processed by a processing head.

Based on another embodiment of the claimed device, the supporting means has a flat planar surface divided into a plurality of part-surfaces and is provided with suction orifices for a vacuum suction system within the part-surfaces. The vacuum suction system holds the pressing plate or endless belt by suction so that it lies flat on the supporting means and it is held in a fixed position during other processing steps performed by the processing head in order to prevent any shifting of the pressing plates or endless belts relative to the surface structuring due to an offset.

As already mentioned in connection with the method, the completed pressing plates or endless belts can be subjected to other treatment processes after structuring. For example, several chromium layers with different degrees of gloss may be applied, in which case full-surface chrome plating takes place and either the raised or deeper lying regions of the surface structuring are covered with a mask so that at least a second chrome plating layer can then be applied. Alternatively, another option is to adjust the degree of gloss using gloss baths, mechanical treatment or surface etching. On completion of these other method steps, the pressing plate or endless belt is ready and can be used for the intended purpose.

The purpose of the surface structuring of the pressing tools produced with the aid of the three-dimensional layered structure, in particular a metal pressing plate or endless belt, is to provide tools which can be used for pressing and/or embossing material plates, plastic films, separating films, PVC surfaces, LVT (luxury vinyl tiles), check cards, passports, credit cards or plastic cards so that a realistic surface structure up to a depth of 500 μm can be obtained during the pressing operation, and digitized data of a 2D-layer of a 3-D topography of a surface structure is used as the basis for controlling x- and y-coordinates for structuring the surface of the pressing tool, and the surface is partially processed and a reproduction of a predefined 3-D topography of a surface structure or a negative of it is obtained on the surface of the pressing tool by applying a layer material.

The invention further relates to a material plate with an at least partially embossed surface produced using a pressing plate or endless belt made as defined in one of the method claims and using a device as defined in one of the device claims.

Based on one advantageous embodiment of the method proposed by the invention, digitized data of a 3-D topography of a surface structure of naturally occurring raw materials is used as a template, such as, for example, wood surfaces or natural minerals, such as natural stone surfaces in particular, or synthetically produced structures such as for, example, ceramic surfaces. The digitized data may be recorded by means of a scanner for example, which realistically records a surface structure using a deflectable mirror system which detects the entire 3-D topography, or by scanning the entire 3-D topography of a surface structure of a template with the aid of a laser beam deflected by at least one mirror and recording the resultant reflections. It may be preferable to use a 3-D microscope with a better depth resolution for this purpose. Digitized data of gray scale images of a surface structure may also be used for surface structuring. In this case, the color scale between white and black is divided into a desired number of intervals. A value is then assigned to each interval. The interval corresponding to the color white or the interval corresponding to the color black is assigned a value of zero. The intervals are then continuously numbered to the opposite end of the color scale. The z-coordinate may assume the values corresponding to the intervals or any multiples thereof and can be used to obtain the 2-D layers.

The particular advantage of this invention resides in the fact that simple carrier bodies are used, for example steel plates, on which a three-dimensional layered structure is either polymerized or sintered in order to impart surface structuring. This obviates the need for complex etching processes requiring an etch resist (mask) to be applied beforehand. This method is therefore distinctive due to the fact that it is an extremely environmentally friendly method even if other metal layers, in particular hard chromium layers, are optionally applied as a finish.

The invention will now be explained in more detail with reference to the drawings.

Of these

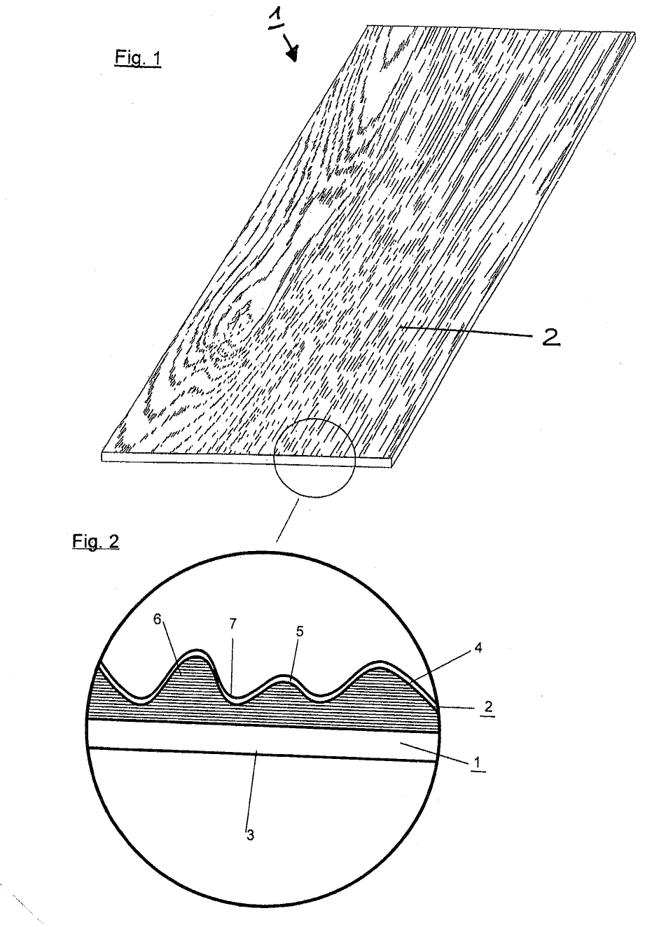

FIG. 1 is a plan view of a pressing plate with surface structuring,

FIG. 2 is a detail on a larger scale illustrating the layer structure of the surface structuring of the pressing plate illustrated in FIG. 1, and

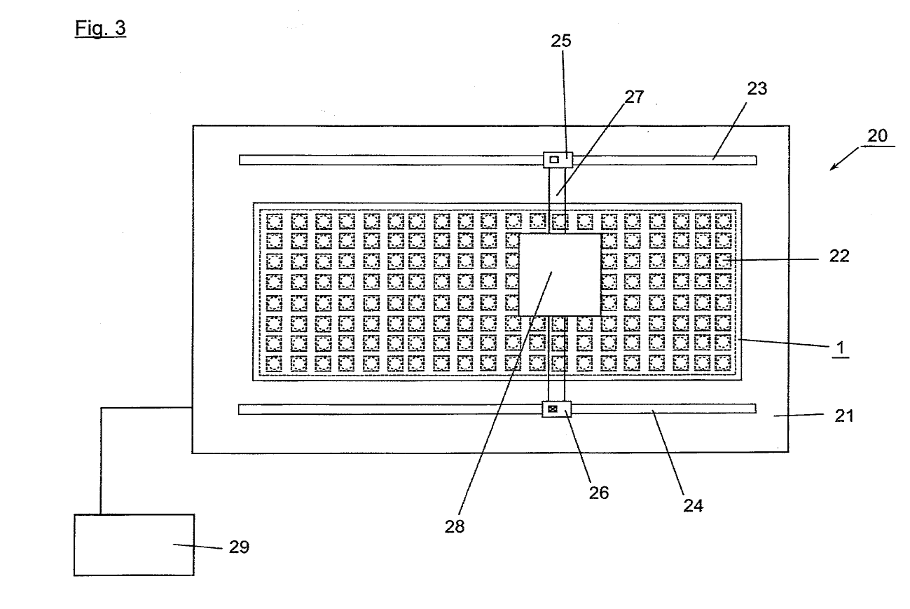

FIG. 3 is a schematic plan view of a device for producing the pressing plates.

FIG. 1 is a perspective diagram illustrating a pressing plate 1 which can be used to produce material plates. In the embodiment illustrated as an example, the pressing plate 1 has surface structuring 2 corresponding to wood grain. The pressing plate 1 is produced by the method proposed by the invention using digitized data of a 3-D topography, whereby structuring is produced by applying a plurality of individual 2-D layers. After completing the surface structuring, one or optionally several chromium layers is/are applied to either the entire surface or part of it. The pressing plate 1 is then ready to be used for pressing material plates.

FIG. 2 is a diagram on a much larger scale illustrating the cross-section of the pressing plate 1 with surface structuring 2. A plurality of individual layers 4 corresponding in terms of their shape to the desired surface structuring are applied to a carrier plate 3. The individual layers 4 are solidified by means of a processing head and then provided with a chromium layer 5. Alternatively, several chromium layers may be used, enabling differing degrees of gloss to be obtained on the raised areas 6 or deeper lying regions 7, for example.

FIG. 3 is a plan view illustrating a device 20 provided as a means of producing the surface structuring of a pressing plate 1. The pressing plate 1 is mounted on a work table 21 which is provided with a plurality of funnel-shaped recesses 22 connected to a vacuum pump so that the pressing plate 1 can be held fixed on the work table 21 virtually completely flat. Disposed along the pressing plate 1 are guide rails 23, 24 on which sliding guides 25, 26 are mounted so as to be displaceable and the sliding guides 25, 26 are each provided with a drive motor. The sliding guides 25, 26 are connected to one another via a cross-member 27 provided as a means of mounting a processing head 28. The processing head 28 can also be moved by drive motors transversely to the longitudinal extension of the guide rails 23, 24 so that the processing head 28 is able to reach every position above the pressing plate 1. The processing head 28 used for the purpose of this invention is a processing head 28 generating electromagnetic radiation or a processing head 28 emitting an electron beam, by means of which the desired surface structuring of the pressing plate 1 is produced. To this end, a plurality of individual layers are applied one on top of the other and solidified by the method proposed by the invention so that the layers adhere to the carrier material 3 of the pressing plate 1 and can then be coated with a chromium layer.

In order to apply the layers, the processing head 28 is moved by a control unit 29 which moves the processing head 28 into the desired position with the aid of drive motors of the sliding guides 25, 26 on the basis of the 3-D topography and the digitized 2-D layers obtained from it.

### LIST OF REFERENCE NUMBERS

1 Pressing plate

2 Surface structuring

3 Carrier material

4 Layers

5 Chromium layer

6 Raised areas

7 Deeper lying regions

20 Device

21 Work table

22 Funnel-shaped recesses

23 Guide rail

24 Guide rail

25 Sliding guide

26 Sliding guide

27 Cross-member

28 Processing head

29 Control unit

1. Method for producing a surface structure of a large-format pressing tool, having at least one edge length of more than one meter, in particular a pressing plate or endless belt, for pressing material plates, plastic films, separating films, PVC surfaces and LVT (luxury vinyl tiles), check cards, passports, credit cards or plastic cards, comprising at least the steps:
providing and using digitized data of a 3-D topography of a surface structure,
creating digitized data of individual 2-D layers of the 3-D topography,
using the digitized data of the 2-D layers to guide and/or position the processing head in an x-y plane or to move a work table in the plane spanned by an x-y coordinate system relative to a stationary processing head, in order to connect a layer material to an existing carrier material or an already completed layer on the basis of the digitized data of the 2-D layers,
and, independently of a repeating pattern, the surface structure is divided into part-regions which are each sequentially processed or at least partially processed by several processing heads in parallel and/or the boundaries of the part-regions are freely selectable and/or the set part-regions have an edge length of 10 cm to 100 cm, depending on the processing head used.

2. Method according to claim 1,
wherein
the layer material is used in solid, liquid, paste, gaseous or powdered form.

3. Method according to claim 1,
wherein
the processing head is provided as a means of generating electromagnetic radiation and in particular infrared radiation or laser light with one or two wavelengths and/or the processing head emits an electron beam.

4. Method according to claim 1,
wherein
the processing head is moved at a distance of 1 cm to 20 cm from the surface, and/or the processing head is moved as a function of a change in distance occurring between the surface and processing head.

5. Method according to claim 1,
wherein
the digitized data used is based on a surface structure of naturally occurring raw materials such as, for example, wood surfaces, or natural minerals, in particular natural stone surfaces, or synthetically produced structures, for example ceramic surfaces, and/or the digitized data is in-register with a decorative layer.

6. Method according to claim 1,
wherein
in order to set up a 3-D topography, a 3-D scanner is used to record the surface structure and compute digitized data which realistically scans the entire surface of the templates by means of deflectable mirrors, or the entire surface structure is scanned by means of a laser beam deflected by means of at least one mirror and the resultant reflections are recorded, or a 3-D microscope is used or a gray scale image of a surface structure is used.

7. Method according to claim 1,
wherein
the digital 3-D data is converted, in particular by interpolation and data reduction, in order to obtain the digitized data of the 2-D layers and control the processing head.

8. Method according to claim 1,
wherein
the boundaries of the part-regions are set so that the boundaries coincide with unprocessed regions of the surface, and/or the set part-regions have an edge length of 50 cm, depending on the processing head used.

9. Method according to claim 1,
wherein
the layer material is a metal powder such as titanium which is sintered and/or the layer material is a liquid or pasty plastic or resin which is polymerized and/or the layer material is a gaseous substance which is solidified and/or the layer material is a single- or multi-component powder which is solidified, polymerized or melted by means of a binding agent or curing agent and/or the layer material is a film which is partially polymerized.

10. Method according to claim 1,
wherein
the beams of a laser or an electron beam of an electron beam source hit the surface at an angle to the vertical (z-coordinate) and/or the laser beam or electron beam is focused on a diameter of 2 to 10 nm.

11. Method according to claim 1,
wherein
measurement points are provided on the surface enabling the position of the processing head to be checked at any time so that a correction can be applied.

12. Device for implementing the method according to claim 1, comprising at least one supporting means for the materials to be processed, at least one processing head and a guide carriage for guiding and/or moving the processing head into any position or moving a work table within a plane spanned by an x-y coordinate system, as well as independent drive elements for moving into position and a control unit provided as a means of guiding, positioning and controlling the processing head or the work table,
wherein
the device is configured so that the x- and y-coordinates are controlled on the basis of the digitized data of individual 2-D layers of the 3-D topography and the device is configured so that the layer material used is solidified by means of the at least one processing head, and the device is additionally configured to divide the surface structure, independently of a repeat pattern, into part-regions which are each sequentially processed or at least partially processed by several processing heads in parallel, and/or the device is configured so that the boundaries of the part-regions are freely selectable and/or the device is configured so that the set part-regions have an edge length of 10 cm to 100 cm, depending on the processing head used.

13. Device according to claim 12,
wherein
one or more processing heads are disposed in one coordinate direction in the plane and can be moved jointly in the direction of the other coordinate and/or the processing heads are disposed at a distance of 1 cm to 20 cm from the surface and process an area with an edge length of 10 cm to 100 cm or preferably 50 cm.

14. Device according to claim 12,
wherein
the supporting means has a flat planar surface divided into a plurality of part-surfaces and is provided with suction orifices for a vacuum suction system within the part-surfaces and/or the processing head comprises an infrared lamp, a UV lamp, a laser or an electron beam source.

15. Pressing plate or endless belt, produced as defined in claim 1 using a device for pressing and/or embossing material plates, plastic films, separating films, PVC surfaces, LVT (luxury vinyl tiles), check cards, passports, credit cards or plastic cards, whereby a surface structure to a depth of 500 μm is obtained by the pressing process, and digitized data of a 2D-layer of a 3-D topography of a surface structure is used for setting up the x-y coordinate system for structuring the surface of the pressing tools, and the surface is partially processed and a reproduction of a predefined 3-D topography of a surface structure or a negative thereof is imparted to the surface of the pressing tool by applying the layer materials.

16. Material plate, with a surface that is at least partially embossed using a pressing plate or endless belt produced as defined in claim 1 using a device with a surface structure of naturally occurring raw materials such as, for example, wood surfaces, or natural minerals, in particular natural stone surfaces, or synthetically produced structures, for example ceramic surfaces.
